(19) United States
(12) Patent Application Publication
(10) Pub. No.: US 2025/0101972 A1
(43) Pub. Date: Mar. 27, 2025

(54) COMPRESSOR

(71) Applicant: SAMSUNG ELECTRONICS CO., LTD., Suwon-si (KR)

(72) Inventors: Kyungmin KIM, Suwon-si (KR); Jiwoong KIM, Suwon-si (KR); Ohyeok KWON, Suwon-si (KR); Yongtae KIM, Suwon-si (KR); Kichul SONG, Suwon-si (KR); Wooju JEON, Suwon-si (KR)

(73) Assignee: SAMSUNG ELECTRONICS CO., LTD., Suwon-si (KR)

(21) Appl. No.: 18/765,466

(22) Filed: Jul. 8, 2024

Related U.S. Application Data
(63) Continuation of application No. PCT/KR2024/008222, filed on Jun. 14, 2024.

(30) Foreign Application Priority Data
Sep. 22, 2023 (KR) 10-2023-0126969

(51) Int. Cl. F04B 39/10; F04B 39/00; F04B 39/08

(52) U.S. Cl. CPC F04B 39/1066; F04B 39/0027; F04B 39/08

(57) ABSTRACT

A compressor may include a valve plate having a suction port, a cylinder forming a compression chamber, a piston in the compression chamber, and which is movable in the compression chamber, a suction valve unit coupled to the valve plate and having a suction valve which is movable, based on movement of the piston, to open and close the suction, and a cushioning member disposed between the valve plate and the suction valve unit, outside of the suction port, and configured to be elastically deformed by contact with the suction valve if the suction valve is moved to open or close the suction port.

### CROSS-REFERENCE TO RELATED APPLICATIONS

This application is a continuation, claiming priority under § 365(c), of International Application No. PCT/KR2024/008222, filed on Jun. 14, 2024, which is based on and claims from the benefit of a Korean patent application number 10-2023-0126969, filed on Sep. 22, 2023, in the Korean Intellectual Property Office, the disclosures of which is incorporated by reference herein in its entirety.

### BACKGROUND

### 1. Field

The disclosure relates to a compressor including a cushioning member for reducing impact force and noise generated when a suction valve opens or closes.

### 2. Description of Related Art

A compressor is a mechanical device that increases the pressure of a gas by reducing its volume. Compressors are largely divided into a positive displacement type, in which the volume of fluid changes, and a turbo type, in which the speed of fluid changes. Between the two (2) types, positive displacement compressors are widely used in small and medium-sized capacities. Positive displacement compressors are further divided into reciprocating compressors and rotating compressors depending on the operation method.

A reciprocating compressor is a compressor that sucks (e.g., intake) and compresses gas by converting the rotation of the motor into the linear reciprocating motion of the piston within the cylinder through the crankshaft and connecting rod.

Rotating compressors include rotary compressors in which a roller is rotated in the cylinder by rotation of a motor to suck or compress gas and scroll compressors that suck and compress gas continuously while spin-scroll-orbiting in a certain direction from a fixed scroll center by rotation of a motor.

A reciprocating compressor includes a valve plate having a suction port and a discharge port through which gas is sucked and discharged, a suction valve that opens and closes the suction port, and a discharge valve that opens and closes the discharge port. During the compression cycle of the compressor, when the piston opens and closes the valve according to the linear reciprocating motion, the valve plate and the valve directly collide with each other, causing an impact force to the valve and noise.

### SUMMARY

Various embodiments of the disclosure may provide a compressor including a cushioning member provided between a suction valve and a valve plate.

A compressor according to an embodiment of the disclosure may include a valve plate having a suction port, a cylinder forming a compression chamber, a piston in the compression chamber, and which is movable in the compression chamber, a suction valve unit coupled to the valve plate and having a suction valve which is movable, based on movement of the piston, to open and close the suction, and a cushioning member disposed between the valve plate and the suction valve unit, outside of the suction port, and configured to be elastically deformed by contact with the suction valve if the suction valve is moved to open or close the suction port.

According to various embodiments of the disclosure, as the cushioning member is provided between the suction valve and the valve plate, the suction valve and the cushioning member collide with each other when the suction valve opens or closes, elastically deforming the cushioning member. At the same time, the cushioning member positioned between the suction valve and the valve plate is supported without escaping off while being elastically deformed. In this case, the elastic deformation of the cushioning member may reduce the impact force applied to the suction valve. Accordingly, it is possible to prevent damage to the suction valve due to impact and to allow the valve to be designed to have a further reduced thickness to enhance the compression efficiency of the compressor. Further, the elastic deformation of the cushioning member may reduce the noise during collision.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an example hermetic reciprocating compressor according to one or more embodiments;

FIG. 2 is a perspective view illustrating the example compressor of FIG. 1 with the container removed according to one or more embodiments;

FIG. 3 is a cross-sectional view taken along line A-A′ of FIG. 2 according to one or more embodiments;

FIG. 4 is an exploded perspective view illustrating an example compressor according to one or more embodiments;

FIG. 5 is a perspective view illustrating an example state in which a valve plate, a suction valve unit, and a gasket are sequentially arranged in a valve assembly according toone or more embodiments;

FIG. 6 is a view illustrating an example fixing structure of a cushioning member according to one or more embodiments;

FIG. 7 is a view illustrating an example fixing structure of a cushioning member according to one or more embodiments;

FIG. 8 is a view illustrating an example fixing structure of a cushioning member constituted of a plurality of segments according to one or more embodiments;

FIG. 9 is a perspective view illustrating an example state in which a suction valve unit and a valve plate are separated according to one or more embodiments;

FIG. 10 is an enlarged view illustrating an example suction valve of a suction valve unit according to one or more embodiments;

FIG. 11 is an enlarged view illustrating an example suction valve of a suction valve unit according to one or more embodiments; and

FIG. 12 is a perspective view illustrating an example state in which a valve plate, a suction valve unit, and a gasket are sequentially arranged in a valve assembly according to one or more embodiments.

The same or similar reference denotations may be used to refer to the same or similar elements throughout the specification and the drawings.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

It will be understood that the term “side,” as used herein, may mean, be referred to as, or interchangeably used as a “surface” or a “surface of a side.”

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Hereinafter, the working principle and embodiments of the disclosure are described with reference to the accompanying drawings.

The compressor 1 described in the disclosure may perform a compression cycle among four cycles of compression, condensation, expansion, and evaporation of the cooling cycle. The compressor 1 may be used in various home appliances such as an air conditioner, a refrigerator, or a freezer having a cooling cycle. For a better understanding of the disclosure, the following description focuses primarily on a hermetic reciprocating compressor 1 but, without limitations thereto, various changes may be made thereto so that the disclosure is applied to rotary compressors or scroll compressors.

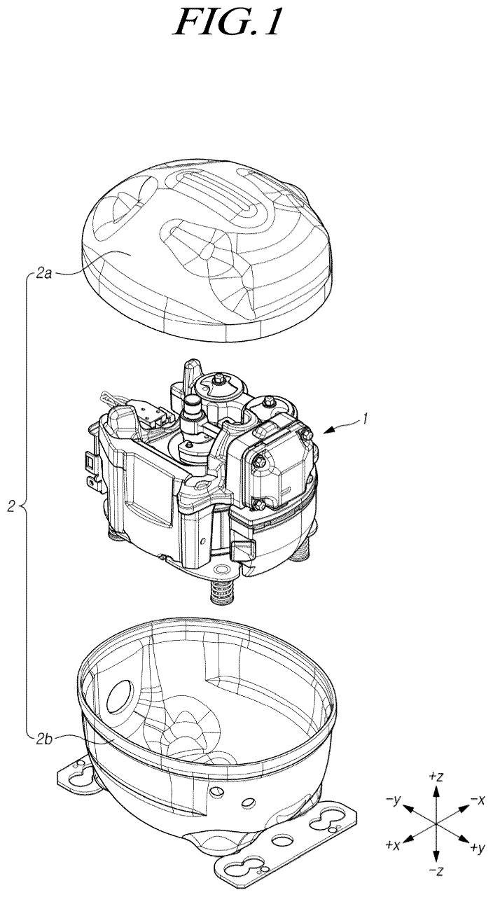

FIG. 1 is a perspective view illustrating a hermetic reciprocating compressor according to an example.

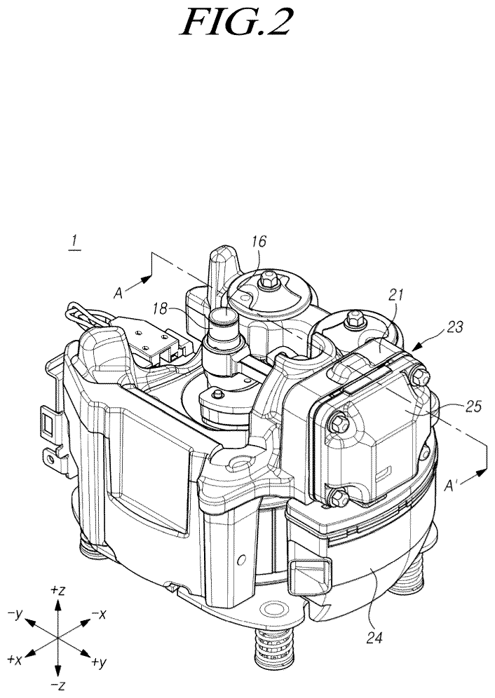

Referring to FIG. 1, a compressor 1 according to an example may be a hermetic reciprocating compressor which is sealed (e.g., airtight or gas tight) and received in a container 2, together with a motor (e.g., the motor 10 of FIG. 2) to be described below. In an example, the container 2 may include an upper container 2a and a lower container 2b. In an example, the compressor 1 may be sealed from the outside by coupling the upper container 2a and the lower container 2b with the compressor 1 received in the lower container 2b.

FIG. 2 is a perspective view illustrating the compressor of FIG. 1 with the container removed.

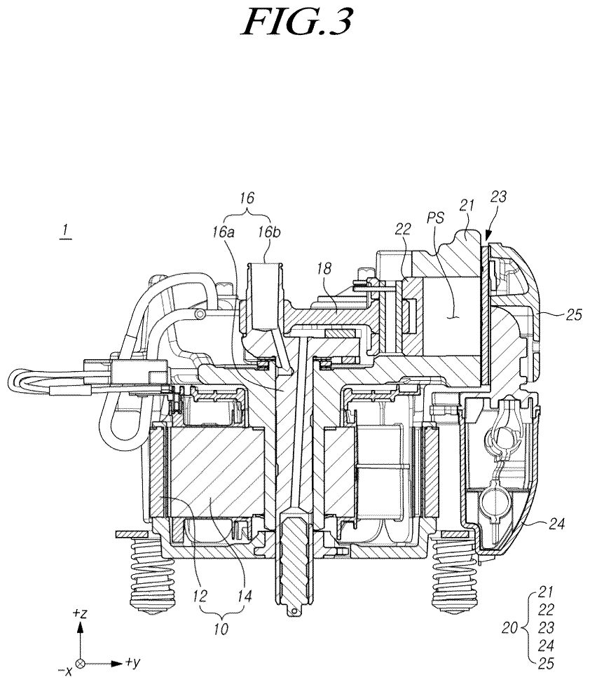

FIG. 3 is a cross-sectional view taken along line A-A′ of FIG. 2.

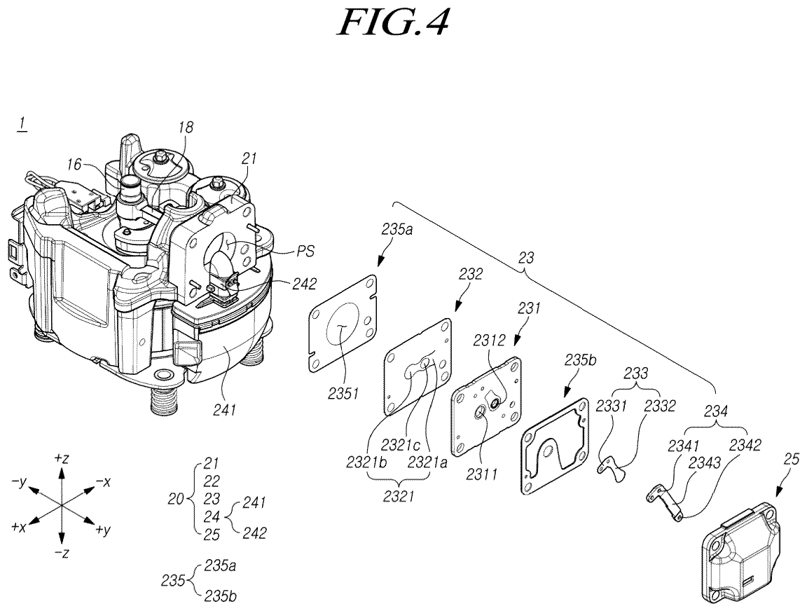

FIG. 4 is an exploded perspective view illustrating a compressor according to an example.

Referring to FIGS. 2 to 4, the compressor 1, according to an embodiment, may include a motor 10 and a cylinder block 20.

According to an example, the motor 10 may include a rotor 12, a stator 14, and a rotation shaft 16 coupled to the rotor 12.

According to an example, the rotation shaft 16 may include a central shaft 16a and an eccentric shaft 16b. In an example, one end portion of a connecting rod 18 may be coupled to the eccentric shaft 16b. In an example, the other end portion of the connecting rod 18 may be coupled to the piston 22 inserted into a compression chamber PS of a cylinder 21, which is described below. In an example, the connecting rod 18 may convert the rotational motion of the rotor 12 into a linear reciprocating motion of the piston 22 disposed in the compression chamber PS to be described below.

According to an example, the cylinder block 20 may include a cylinder 21 provided with a cylindrical compression chamber PS therein, a piston 22 inserted into the compression chamber PS to reciprocate, a valve assembly 23 provided on one side of the cylinder 21, a suction muffler 24 for sucking gas (e.g., refrigerant) from the outside, and a cylinder head 25 for forming a discharge space (or a discharge chamber) for discharging the gas compressed in the cylinder 21.

In an example, the cylinder block 20 may further include a second gasket 235b (e.g., a head gasket) disposed between the valve assembly 23 and the cylinder head 25 to seal the discharge space of the cylinder head 25 to be described below.

According to an example, the cylinder 21 may have a hexahedral shape. In an example, the cylinder 21 may include a cylindrical compression chamber PS penetrating the center of the cylinder 21.

According to an example, the piston 22 may be inserted into the compression chamber PS of the cylinder 21. In an example, the piston 22 may be coupled to the connecting rod 18 behind the cylinder 21. The piston 22 may reciprocate back and forth inside the compression chamber PS through the connecting rod 18 when the motor 10 rotates. The volume of the inner space of the compression chamber PS may change due to the forward and backward reciprocating motion of the piston 22.

According to an example, the valve assembly 23 may be coupled to the outside of the cylinder 21. In an example, the valve assembly 23 may be disposed in front of the cylinder 21 (e.g., in the +x-axis direction) to cover the compression chamber PS of the cylinder 21. In an example, the valve assembly 23 may selectively communicate the compression chamber PS of the cylinder 21 with the suction muffler 24 or the compression chamber PS with the discharge space of the cylinder head 25.

According to an example, the valve assembly 23 may include a valve plate 231 including a suction port 2311 through which gas is sucked and a discharge port 2312 through which gas is discharged, a suction valve unit 232 for opening or closing the suction port 2311 of the valve plate 231 inside the compression chamber PS, a discharge valve 233 for opening or closing the discharge port 2312 outside the compression chamber PS, a valve keeper 234 disposed to cover the discharge valve 233, and a gasket 235 for preventing gas leakage to the outside.

According to an example, the suction port 2311 of the valve plate 231 may communicate with the compression chamber PS and/or the suction muffler 24 by the opening/closing operation of the suction valve unit 232 according to the operation of the piston 22. In an example, the discharge port 2312 of the valve plate 231 may communicate with the discharge space of the compression chamber PS and/or the cylinder head 25 by the opening/closing operation of the discharge valve 233 according to the operation of the piston 22. In an example, the suction port 2311 may be provided to be larger than the discharge port 2312.

According to an example, the suction valve unit 232 may be formed of an elastic plate. For example, the suction valve unit 232 may be formed of an elastic plate corresponding to one side (e.g., a surface facing in the +y-axis direction) of the cylinder 21. In an example, the suction valve unit 232 may be disposed between the cylinder 21 and the valve plate 231. In an example, the suction valve unit 232 may be coupled to the inner side 231a of the valve plate 231. Here, the inner side 231a of the valve plate 231 may mean one side (e.g., surface) of the valve plate 231 facing the cylinder 21.

According to an example, the suction valve unit 232 may include a suction valve 2321 disposed to cover the suction port 2311 of the valve plate 231. In an example, the suction valve 2321 may be elastically deformed (e.g., change shape or form) according to the operation of the piston 22 to open or close the suction port 2311 of the valve plate 231.

According to an example, the suction valve 2321 may be integrally formed with the plate constituting the suction valve unit 232 by a punching or shearing operation. However, the disclosure is not limited thereto, and the suction valve 2321 may be manufactured as a separate component and coupled to the valve plate 231.

According to an example, the suction valve 2321 may include a suction valve neck 2321a having one end connected to the plate constituting the suction valve unit 232 and a suction valve head 2321b integrally extending from the suction valve neck 2321a. For example, the suction valve neck 2321a may correspond to a fixed end of the suction valve 2321, and the suction valve head 2321b may correspond to a free end of the suction valve 2321.

According to an example, a valve hole 2321c corresponding to the discharge port 2312 of the valve plate 231 may be provided in the suction valve neck 2321a.

According to an example, the discharge valve 233 may be formed of an elastic plate. In an example, the discharge valve 233 may be disposed to cover the discharge port 2312 on the outer side 231b of the valve plate 231. In an example, the discharge valve 233 may be elastically deformed (e.g., change shape or form) according to the operation of the piston 22 to open or close the discharge port 2312 of the valve plate 231.

According to an example, the discharge valve 233 may include a fixed end portion 2331 fixed to the valve plate 231 by a fastening member (e.g., a bolt) and a free end portion 2332 integrally extend portioning from the fixed end portion 2331. The discharge valve 233 may block (or cover) the discharge port 2312, and if the gas pressure (or compressive force) of the compression chamber PS reaches a predetermined range, the free end portion 2322 may be elastically deformed (e.g., change shape or form) to open the discharge port 2312.

According to an example, the valve keeper 234 may be disposed to cover the discharge valve 233. According to an example, the valve keeper 234 may include a pair of fixed end portions (2341 and 2342) positioned at two (2) opposite ends thereof and coupled to the valve plate 231 by fastening members (e.g., bolts), and an inner central portion 2343 bent from each of the fixed end portions 2341 and 2342 to be convex in a direction (e.g., the +y-axis direction) away from the discharge valve 233.

According to an example, the valve keeper 234 may prevent over-deformation of the discharge valve 233 by restricting the discharge valve 233 from being deformed by a predetermined angle or more.

According to an example, the gasket 235 may seal gaps between the suction valve unit 23 and components coupled to the suction valve unit 23. According to an example, the gasket 235 may include a first gasket 235a sealing between the cylinder 21 and the suction valve unit 232 and a second gasket 235b sealing between the cylinder head 25 and the suction valve unit 232.

According to an example, the first gasket 235a may be disposed between one side (e.g. the side facing the -y axis) of the cylinder 21 and the suction valve unit 232. In an example, the first gasket 235a may include a gasket hole 2351 corresponding to an opening of the compression chamber PS provided in the outward direction (e.g., the +y-axis direction). In an example, the first gasket 235a may be disposed in a gap (e.g., space) between the suction valve unit 232 and the cylinder 21 to surround the opening of the compression chamber PS.

According to an example, the second gasket 235b may be disposed between one side (e.g. the side facing the +y axis) of the valve plate 231 and the cylinder head 25. In an example, the second gasket 235b may be disposed in a gap (e.g., space) between the valve plate 231 and the cylinder head 25 along an edge of the valve plate 231 to surround the suction port 2311 and/or the discharge port 2312 of the valve plate 231.

When the compressor 1 is operated, the gas may be prevented from leaking out of the suction muffler 24 and/or the cylinder head 25 by the gaskets 235a and 235b.

According to an example, the suction muffler 24 includes a suction chamber 241 for reducing noise caused during gas suction or intake process and a gas suction pipe 242 for guiding the gas passing through the suction chamber 241 to the suction port 2311 of the valve plate 231. According to an example, the suction chamber 241 may include a plurality of expansion parts (not shown) and a connection passage (not shown) connecting the plurality of expansion parts to a narrow width.

According to an example, the cylinder head 25 may be coupled to the valve plate 231 with a predetermined space (e.g., a discharge space) therein. The cylinder head 25 may include a discharge muffler (not shown) for reducing noise in the discharge space.

Although not specifically illustrated in the drawings, the compression cycle of the compressor 1 is described. If the piston 22 is retracted (e.g., moved in the-y-axis direction) in the cylinder 21 during the compression cycle, the suction valve unit 232 (specifically, the suction valve 2321) facing the inner side 231a of the valve plate 231 and blocking the suction port 2321 may be elastically deformed (e.g., change shape or form) by the suction force, and thus the suction port 2311 may be opened. As a result, the gas is sucked through the suction port 2311 to fill (or occupy) the compression chamber PS. In this case, the discharge valve 233 facing the outer side 231b of the valve plate 231 and blocking the discharge port 2312 may seal the discharge port 2312 by the discharge pressure.

Further, if the piston 22 moves forward (e.g., moves in the +y-axis direction) in the cylinder 21 during the compression cycle, the gas in the compression chamber PS may be compressed. By this compressive force, the discharge valve 233 positioned on the outer side 231b of the valve plate 231 and blocking the discharge port 2312 may be elastically deformed and opened. As a result, the gas is discharged to the discharge space of the cylinder head 25 through the discharge port 2312. In this case, the suction valve unit 232 blocking the suction port 2312 may seal the suction port 2311 by a compressive force. The gas may be compressed/sucked in the compression chamber PS by the forward/backward operation of the piston 22.

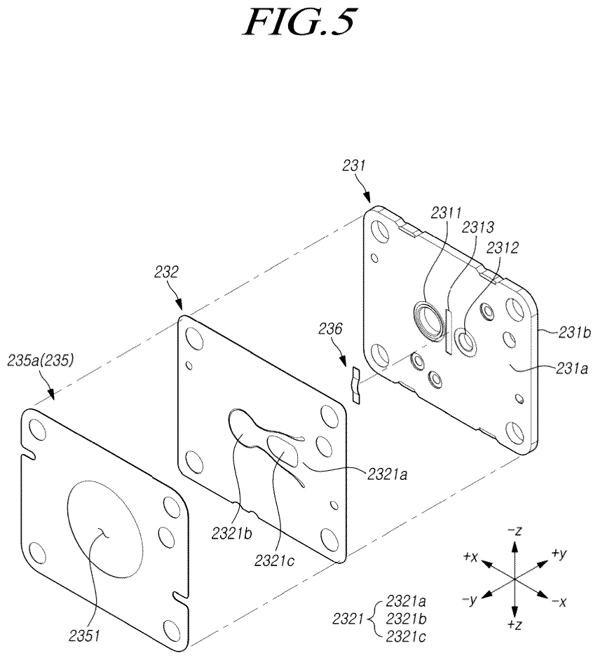

FIG. 5 is a perspective view illustrating a state in which a valve plate, a suction valve unit, and a gasket are sequentially arranged in a valve assembly according to an example.

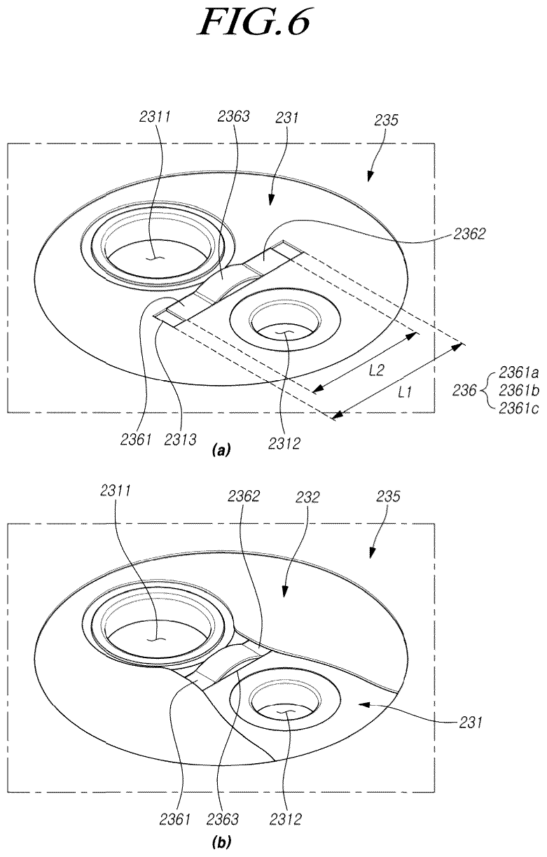

FIG. 6 is a view illustrating a fixing structure of a cushioning member according to an example.

FIG. 6(a) is a partial enlarged view of the valve assembly 23 in a state in which the suction valve unit 232 is removed, and FIG. 6(b) is a partial enlarged view of the valve assembly 23 in a state in which the suction valve 2321 of the suction valve unit 232 is removed.

Referring to FIGS. 5 and 6, the valve plate 231 according to an example may be provided on the inner side 231a and may include a receiving portion 2313 receiving a cushioning member 236 to be described below.

According to an example, the receiving portion 2313 may be recessed from the inner side 231a of the valve plate 231 to a predetermined depth. In an example, the receiving portion 2313 may be formed to extend in a predetermined length L1 in a vertical direction (e.g., a +z-axis direction). In an example, the extension length L1 of the receiving portion 2313 may be designed to be longer than the total length L2 of the cushioning member 236. For example, the length L1 of the receiving portion 2313 may be designed taking into account a stretching range of the cushioning member 236 according to the opening/closing operation of the suction valve 2321.

In an example, the receiving portion 2313 may be positioned between the suction port 2311 and the discharge port 2312 of the valve plate 231.

According to an example, the valve assembly 23 may include a cushioning member 236 that reduces the impact force transferred to the suction valve 2321 during the opening/closing operation of the suction valve 2321 according to the operation of the piston 22.

According to an example, if the suction valve 2321 is elastically deformed (e.g., change shape or form) and then restored by the operation of the piston 22, the cushioning member 236 may collide with the suction valve 2321, and as the cushioning member 236 is elastically deformed by the collision, the impact force received by the suction valve 2321 may be reduced. Further, as the impact force received by the suction valve 2321 is reduced in the cushioning member 236, noise generated during the collision may also be reduced. Accordingly, if the impact force received by the suction valve 2321 is reduced, the suction valve 2321 may be designed to be thinner, thereby enhancing the compression efficiency of the compressor 1.

According to an example, the cushioning member 236 may be disposed between the valve plate 231 and the suction valve unit 232. In an example, the cushioning member 236 may be received in the receiving portion 2313 of the valve plate 231 and may be disposed on the inner side 231a of the valve plate 231. In an example, the cushioning member 236 may be disposed outside the suction port 2311 and the discharge port 2312 on the inner side 231a of the valve plate 231. In an example, the cushioning member 236 may be positioned between the suction port 2311 and the discharge port 2312 of the valve plate 231.

According to an example, the cushioning member 236 may be implemented in the form of a leaf spring (e.g., semi-elliptical spring or elliptical spring), but the disclosure is not limited thereto. In an example, the cushioning member 236 may be formed of an elastic plate, such as the suction valve unit 232.

According to an example, the cushioning member 236 may include one end 2361 and the other end 2362 in the form of a flat portion, and a collision portion 2363 connecting the one end 2361 and the other end 2362 and bent convexly toward the suction valve unit 232. The collision portion 2363 may also be referred to as a bending portion. In an example, the collision portion 2363 of the cushioning member 236 may form a gap with the bottom side (e.g., surface) of the receiving portion 2313 when the receiving portion 2313 is received.

In an example, the collision portion 2363 of the cushioning member 236 may collide with the suction valve 2321 during the opening/closing operation of the suction valve 2321 and may be elastically deformed toward the receiving portion 2313. At the same time, the two (2) opposite end portions (2361 and 2362) of the cushioning member 236 may be stretched (e.g., extended) into an empty space between the cushioning member 236 and the receiving portion 2313 in the receiving portion 2313.

According to an example, as the two (2) opposite ends (2361 and 2362) of the cushioning member 236 are disposed in the receiving portion 2313 between the valve plate 231 and the suction valve unit 232, the cushioning member 236 may be prevented from escaping to the outside of the receiving portion 2313 during the opening/closing operation of the suction valve 2321. As illustrated in FIG. 6(b), if the valve plate 231 and the suction valve unit 232 are coupled, the suction valve unit 232 and at least part of the two (2) opposite ends (2361 and 2362) of the cushioning member 236 may overlap each other, and thus the cushioning member 236 may be fixedly disposed inside the receiving portion 2313. However, the fixing structure of the cushioning member 236 is not limited thereto.

According to an example, one of one end or the other end of the cushioning member 236 may be bent inward toward the receiving portion 2313, different from illustration in FIG. 6, and the receiving portion 2313 may include a fixing groove (not shown) to which one end or the other end of the cushioning member 236 bent inward is fitted/inserted. In this case, the cushioning member 236 may reduce the impact force received by the suction valve 2321 as one end or the other end not fixed to the fixing groove is stretched during the opening/closing operation of the suction valve 2321.

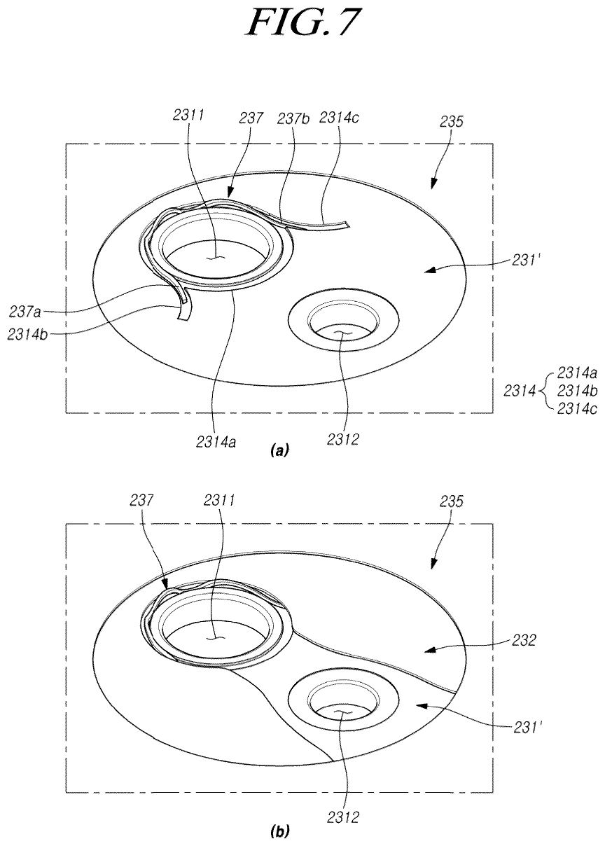

FIG. 7 is a view illustrating a fixing structure of a cushioning member according to an example.

FIG. 7(a) is a partial enlarged view of the valve assembly 23′ in a state in which the suction valve unit 232 is removed, and FIG. 7(b) is a partial enlarged view of the valve assembly 23′ in a state in which the suction valve 2321 of the suction valve unit 232 is removed.

Referring to FIG. 7, the valve plate 231′ according to an example may include a receiving portion 2314 surrounding the suction port 2311 and receiving a cushioning member 237 to be described below. According to an example, the receiving portion 2314 may be recessed to a predetermined depth to receive the cushioning member 237.

According to an example, the receiving portion 2314 may include a main receiving groove 2314a extending along the circumference of the suction port 2311, and a plurality of sub receiving grooves (2314b and 2314c) extending outward from the main receiving groove 2314a.

In an example, the main receiving groove 2314a may have a ring shape.

In an example, the extension length of each of the sub receiving grooves 2314b may be designed to be longer than the two (2) opposite ends (237a and 237b) of the cushioning member 237 received in the receiving portion 2314. For example, the extension length of the sub receiving groove 2314b may be designed taking into account the stretching range of the cushioning member 237 according to the opening/closing operation of the suction valve 2321.

According to an example, the valve assembly 23 may include a cushioning member 237 configured to reduce the impact force transferred to the suction valve 2321 during the opening/closing operation of the suction valve 2321 according to the operation of the piston 22.

According to an example, unlike the cushioning member 236 illustrated in FIG. 6, the cushioning member 237 may be implemented in the form of a wave spring. According to an example, the cushioning member 237 may have a free curved shape so that the shape thereof may change by an external force. For example, the cushioning member 237 may have a wavy shape whose height changes in the length direction.

According to an example, the cushioning member 237 may be received in the receiving portion 2314 and may be disposed adjacent to the suction port 2311. In an example, the cushioning member 237 may be received in the receiving portion 2314 and may be disposed to surround at least a portion of the suction port 2311.

In an example, two (2) opposite ends (237a and 237b) of the cushioning member 237 may be received in corresponding sub receiving grooves (2314b and 2314c), respectively.

According to an example, when the suction valve 2321 is opened or closed, the cushioning member 237 may collide with the suction valve 2321 and may be elastically deformed (e.g., change shape or form) along the extending direction of the receiving portion 2313. The two (2) opposite end portions (237a and 237b) of the cushioning member 237 may be stretched (e.g., extended) into an empty space between the cushioning member 237 and the sub receiving grooves (2314a and 2314b) in the receiving portion 2314.

According to an example, since the two (2) opposite ends (237a and 237b) of the cushioning member 237 are disposed in the sub receiving grooves (2314b and 2314c) between the valve plate 231′ and the suction valve unit 232, the cushioning member 237 may be prevented from escaping to the outside of the receiving portion 2314 during the opening/closing operation of the suction valve 2321. As illustrated in FIG. 7(b), if the valve plate 231′ and the suction valve unit 232 are coupled, the suction valve unit 232 and at least part of the two (2) opposite ends (237a and 237b) of the cushioning member 237 may overlap each other, and thus the cushioning member 237 may be fixedly disposed inside the receiving portion 2314.

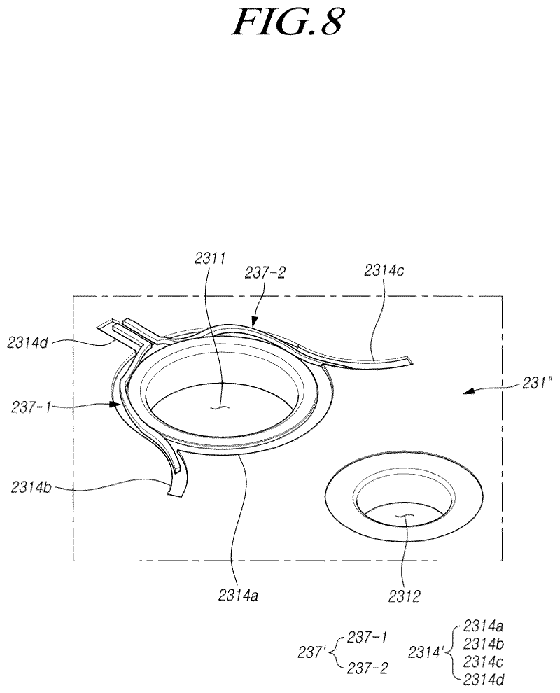

FIG. 8 is a view illustrating a fixing structure of a cushioning member constituted of a plurality of segments.

Referring to FIG. 8, the cushioning member 237′ according to an example may include a plurality of separate segments (237-1 and 237-2) different from the cushioning member 237 illustrated in FIG. 7. For example, the cushioning member 237′ may include a first segment 237-1 and a second segment 237-2. However, in the disclosure, the number of segments is not limited thereto. Each of the segments (237-1 and 237-2) may have a length corresponding to about half of the total length of the cushioning member 237 of FIG. 7.

According to an example, the valve plate 231″ may include a receiving portion 2314′ having substantially the same structure as the above-described receiving portion 2314 illustrated in FIG. 7.

In an example, the receiving portion 2314′ may include a main receiving groove 2314a and a plurality of sub receiving grooves (2314b, 2314c, and 2314d). As compared with the receiving portion 2314 of FIG. 7, the receiving portion 2314′ of FIG. 8 may include more sub receiving grooves 2314d to receive the separated segments (237-1 and 237-2).

In an example, the plurality of sub receiving grooves (2314b, 2314c, and 2314d) may be disposed at positions having considered the lengths of the segments 237-1 (and 237-2) received in the receiving portion 2314′ when the cushioning member 237′ is received. For example, if the segments (237-1 and 237-2) have the same length, the plurality of sub receiving grooves (2314b, 2314c, and 2314d) may be spaced apart from each other at the same interval along the main receiving groove 2314a.

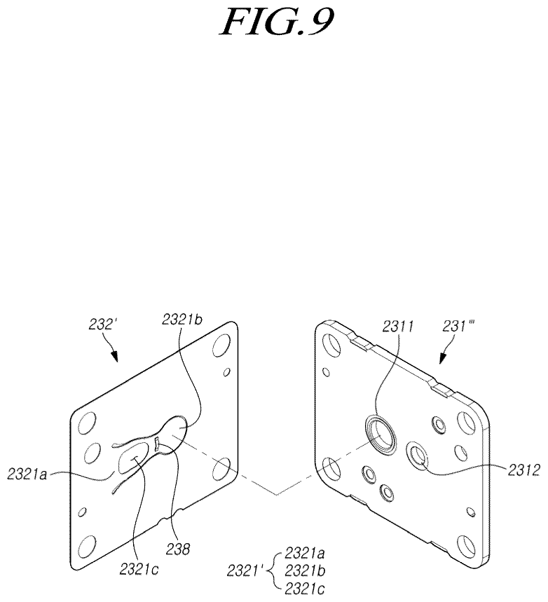

FIG. 9 is a perspective view illustrating a state in which a suction valve unit and a valve plate are separated according to an example.

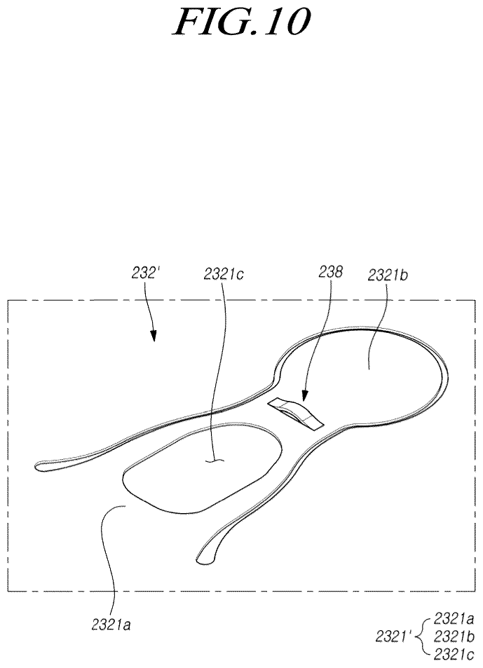

FIG. 10 is an enlarged view illustrating a suction valve of a suction valve unit according to an example.

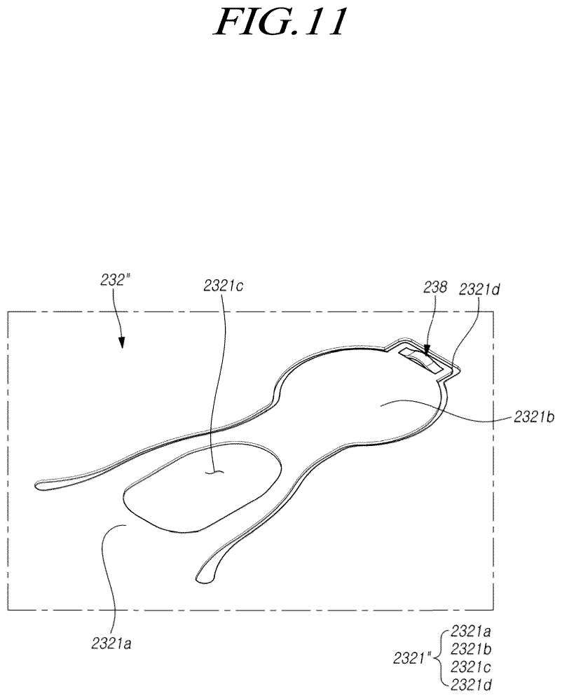

FIG. 11 is an enlarged view illustrating a suction valve of a suction valve unit according to an example.

Referring to FIGS. 9 to 11, the suction valve unit (232′ and 232″) according to an embodiment may include a cushioning member 238 that reduces an impact force transferred to the suction valve (2321′ and 2321″) in an opening/closing operation of the suction valves (2321′ and 2321″) according to an operation of the piston 22.

According to an example, the cushioning member 238 may be integrally formed with the suction valve (2321′ and 2321″). In an example, the cushioning member 238 may be implemented in the form of a leaf spring in the suction valve (2321′ and 2321″). For example, the cushioning member 238 may be configured to have substantially the same structure, shape, and/or function as the cushioning member 236 illustrated in FIG. 6. In an example, the cushioning member 238 may be integrally formed with the plate constituting the suction valve (2321′ and 2321″) by a punching or shearing operation.

According to an example, the cushioning member 238 may be provided between the suction valve neck 2321a and the suction valve head 2321b of the suction valve 2321′ (see FIGS. 9 and 10).

According to an example, the cushioning member 238 may be provided in the cushioning member forming portion 2321d extending from the suction valve head 2321b of the suction valve 2321″ (see FIG. 11). The cushioning member forming portion 2321d may be formed at a position not facing the suction port 2311 of the valve plate 231 when the suction valve 2321″ is opened or closed.

As such, if the cushioning member 238 is integrally formed with the suction valve (2321′ and 2321″), unlike the cushioning members (236 and 237) of FIGS. 5 to 8 provided with separate components, there is no need for a separate structure for fixing and/or supporting the cushioning member.

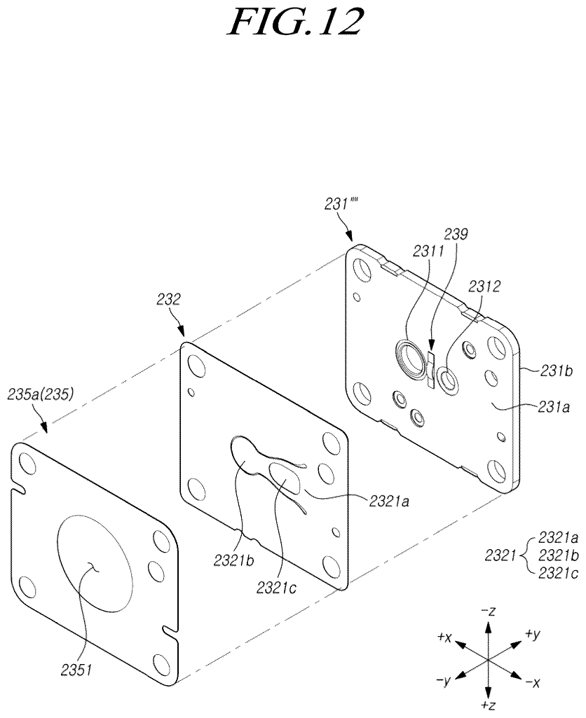

FIG. 12 is a perspective view illustrating a state in which a valve plate, a suction valve unit, and a gasket are sequentially arranged in a valve assembly according to an example.

Referring to FIG. 12, the valve plate 231″″ according to an example may include a cushioning member 239 that is configured to reduce an impact force transferred to the suction valve 2321 during an opening/closing operation of the suction valve 2321 according to an operation of the piston 22.

According to an example, the cushioning member 239 may be integrally formed with the valve plate 231″″. In an example, the cushioning member 239 may be implemented in the form of a leaf spring on the valve plate 231″″. For example, the cushioning member 239 may be configured to have substantially the same structure, shape, and/or function as the cushioning member 236 illustrated in FIG. 6. In an example, when the valve plate 231″″ is formed of a thin plate, the cushioning member 239 may be integrally formed with the plate constituting the valve plate 231″″ by being punched or sheared on the valve plate 231″″.

According to an example, the cushioning member 239 may be provided at a position not facing the suction valve head 2321b of the suction valve 2321 on the valve plate 231″ during the opening/closing operation of the suction valve 2321. For example, the cushioning member 239 may be provided between the suction port 2311 and the discharge port 2312 of the valve plate 231″″.

As such, when the cushioning member 238 is integrally formed with the valve plate 231″″, there is no need for a separate structure for fixing and/or supporting the cushioning member, unlike the cushioning members 236 and 237 of FIGS. 5 to 8 provided with separate components.

A compressor 1 according to an example of the disclosure may comprise a valve plate (231, 231′ and 231″) having a suction port 2311. The compressor 1 according to an example of the disclosure may comprise a cylinder 21 forming a compression chamber PS. The compressor 1 according to an example of the disclosure may comprise a piston 22 in the compression chamber PS, and which is movable in the compression chamber PS. The compressor 1 according to an example of the disclosure may comprise a suction valve unit (232, 232′ and 232″) coupled to the valve plate (231, 231′ and 231″) and having a suction valve 2321 which is movable, based on movement of the piston 22, to open and close the suction port 2311 opening and closing the suction port 2311. The compressor 1 according to an example of the disclosure may comprise a cushioning member (236, 237, 237′ and 238) disposed between the valve plate (231, 231′ and 231″) and the suction valve unit (232, 232′ and 232″), outside of the suction port 2311, and elastically deformed by contact with the suction valve unit (232, 232′ and 232″) if the suction valve 2321 is moved to open or close the suction port 2311.

According to an example, the cushioning member 236 may include a leaf spring.

According to an example, the valve plate (231, 231′ and 231″) may further include a discharge port 2312 and a discharge valve 233 coupled to the valve plate (231, 231′ and 231″) and which is movable, based on movement of the piston 22, to open and close the discharge port 2312. According to an example, the cushioning member 236 may does not block the suction port 2311 and does not block the discharge port 2312.

According to an example, the valve plate (231, 231′ and 231″) may include a receiving portion (2313, 2314 and 2314′) recessed from one side (e.g., surface) facing the suction valve unit (232, 232′ and 232″) to receive the cushioning member (236, 237 and 237′).

According to an example, the receiving portion 2313 may has an extension length L1 extending in a length direction of the cushioning member 236.

According to an example, an extension length L1 of the receiving portion 2313 may be longer than a length L2 of the cushioning member 236.

According to an example, the cushioning member (237 and 237′) may include a wave spring.

According to an example, the cushioning member 237′ may include a plurality of segments (237-1 and 237-2).

According to an example, the cushioning member (237 and 237′) may surround (e.g., cover) at least a portion of the suction port 2311.

According to an example, the receiving portion (2314 and 2314′) may include a ring-shaped main receiving groove 2314a extending along the suction port 2311, and a plurality of sub receiving grooves (2314b, 2314c and 2314d) extending outward from the ring-shaped main receiving groove 2314a.

According to an example, two (2) opposite ends (237a and 237b) of the cushioning member (237 and 237′) may be separately received in one and another, respectively, of the plurality of sub receiving grooves (2314b, 2314c and 2314d).

According to an example, the suction valve unit 232 may include an elastic plate. The suction valve 2321 may be formed in the elastic plate and be configured so that movement to open the suction valve 2321 causes the suction valve 2321 to be elastically deformed (e.g., change shape or form) from a side of the elastic plate. According to an example, the receiving portion (2313, 2314 and 2314′) may be configured to receive two (2) opposite ends of the cushioning member (236, 237′ and 237″) so as to overlap a remaining area of the elastic plate where the suction valve 2321 is not formed.

According to an example, the suction valve unit (232′ and 232″) may include an elastic plate. The suction valve 2321 may be formed in the elastic plate and be configured so that movement to open the suction valve 2321 causes the suction valve 2321 to be elastically deformed from a side of the elastic plate. According to an example, the cushioning member 238 may be integrally formed with the suction valve 2321.

According to an example, the suction valve 2321 may include a valve neck 2321a and a valve head 2321b extending from the valve neck 2321a and having a shape corresponding to the suction port 2311. According to an example, the cushioning member 238 may be disposed between the valve neck 2321a and the valve head 2321b.

According to an example, the suction valve 2321 may include a valve neck 2321a, a valve head 2321b extending from the valve neck 2321a and having a shape corresponding to the suction port 2311, and a cushioning member forming portion 2321d extending from the valve head 2321b. According to an example, the cushioning member 238 may be disposed on the cushioning member forming portion 2321d.

What is claimed is:

1. A compressor comprising:
a valve plate having a suction port;
a cylinder forming a compression chamber;
a piston in the compression chamber, and which is movable in the compression chamber;
a suction valve unit coupled to the valve plate and having a suction valve which is movable, based on movement of the piston, to open and close the suction port; and
a cushioning member disposed between the valve plate and the suction valve unit, outside of the suction port, and configured to be elastically deformed by contact with the suction valve if the suction valve is moved to open or close the suction port.

2. The compressor of claim 1, wherein the cushioning member includes a leaf spring.

3. The compressor of claim 1, wherein
the valve plate further includes:
a discharge port, and
a discharge valve coupled to the valve plate and which is movable, based on movement of the piston, to open and close the discharge port, and
the cushioning member does not block the suction port and does not block the discharge port.

4. The compressor of claim 1, wherein the valve plate includes a receiving portion recessed from a side facing the suction valve unit to receive the cushioning member.

5. The compressor of claim 4, wherein the receiving portion has an extension length extending in a length direction of the cushioning member.

6. The compressor of claim 5, wherein the extension length of the receiving portion is longer than a length of the cushioning member.

7. The compressor of claim 1, wherein the cushioning member includes a wave spring.

8. The compressor of claim 7, wherein the cushioning member includes a plurality of segments.

9. The compressor of claim 1, wherein the cushioning member surrounds at least a portion of the suction port.

10. The compressor of claim 4, wherein
the receiving portion includes:
a ring-shaped main receiving groove extending along the suction port, and
a plurality of sub receiving grooves extending outward from the ring-shaped main receiving groove.

11. The compressor of claim 10, wherein two (2) opposite ends of the cushioning member are separately received in one and another, respectively, of the plurality of sub receiving grooves.

12. The compressor of claim 4, wherein
the suction valve unit includes an elastic plate,
the suction valve is formed in the elastic plate and is configured so that movement to open the suction valve causes the suction valve to be elastically deformed from a side of the elastic plate, and
the receiving portion is configured to receive two (2) opposite ends of the cushioning member so as to overlap a remaining area of the elastic plate where the suction valve is not formed.

13. The compressor of claim 1, wherein
the suction valve unit includes an elastic plate,
the suction valve is formed in the elastic plate and is configured so that movement to open
the suction valve causes the suction valve to be elastically deformed from a side of the elastic plate, and
the cushioning member is integrally formed with the suction valve.

14. The compressor of claim 13, wherein
the suction valve includes:
a valve neck, and
a valve head extending from the valve neck and having a shape corresponding to the suction port, and
the cushioning member is disposed between the valve neck and the valve head.

15. The compressor of claim 13, wherein
the suction valve includes:
a valve neck,
a valve head extending from the valve neck and having a shape corresponding to the suction port, and
a cushioning member forming portion extending from the valve head, and
the cushioning member is disposed on the cushioning member forming portion.
